(19) United States
(12) Patent Application Publication
(10) Pub. No.: US 2019/0211757 A1
(43) Pub. Date: Jul. 11, 2019

(54) Internal Combustion Engine Fuel Gas Blending System

(71) Applicant: AGGREKO, LLC, New Iberia, LA (US)

(72) Inventor: Geoff BLAND, Lafayette, LA (US)

(73) Assignee: Aggreko, LLC, New Iberia, LA (US)

(21) Appl. No.: 16/312,701

(22) PCT Filed: Jul. 6, 2017
(86) PCT No.: PCT/US2017/040904

§ 371 Date: Dec. 21, 2018

Related U.S. Application Data
(60) Provisional application No. 62/359,751, filed on Jul. 8, 2016.

(51) Int. Cl. F02D 19/08; F02B 43/12; F02D 19/06; F02C 3/22; F02C 9/40; F02D 41/00; F02M 21/02; F02D 41/14

(52) U.S. Cl. CPC F02D 19/081; F02B 2043/103; F02D 19/0647; F02D 19/0607; F02D 19/0634; F02C 3/22; F02C 9/40; F02D 41/0065; F02M 21/0218; F02M 21/0287; F02D 41/0027; F02D 41/1454; F05D 2220/32; F02D 2200/0611; F02B 43/12

(57) ABSTRACT

A fuel gas blending system for internal combustion engines combines two or more gas streams to achieve a blended fuel gas having a suitable heating value (HV) for a given engine. A relatively high HV gas, for example gas produced from an oil and/or gas well, or containerized propane, is blended with a relatively low HV gas, for example nitrogen. The blended gas achieves a fuel gas with a suitable HV. Suitable means for combining the gas streams, analyzing the blended gas stream for HV and other properties, and adjusting the blend as needed are all provided. The system permits use of available gaseous fuel sources, even if not suitable in an unblended state, to efficiently fuel internal combustion engines.

### CROSS REFERENCE TO RELATED APPLICATIONS

This non-provisional patent application claims priority to U.S. provisional patent application Ser. 62/359,751, filed Jul. 8, 2016, for all purposes. The disclosure of that provisional patent application is incorporated herein, to the extent not inconsistent with this application.

### BACKGROUND

### Field of the Invention

This invention relates to apparatus and method for producing a fuel gas stream having desired composition and properties, in particular a desired heating value property, for internal combustion engines. Internal combustion engines or simply “engines” are referred to herein in the broadest sense, to include but not be limited to turbines, piston engines, rotary engines, etc.

Issues arise when engines are sought to be fueled by hydrocarbon gases which do not comprise a desired composition, in particular a desired heating value. While a given engine might be capable of running on fuel gas streams of different compositions, depending on the engine design and the fuel gas composition, engine power output may be seriously compromised.

An exemplary setting is when an engine is to be fueled by natural gas produced from an oil/gas well, namely gas straight from the well, unprocessed save for primary separation (i.e. in a multi-phase flow, separation of oil and/or condensate, and produced water, from the natural gas stream). The well may produce a sufficient quantity of natural gas, and therefore be a cost-effective source of fuel for the engine, but the produced natural gas may have a heat value (HV, which is a measure of the energy contained in a given volume of the gas) which is too high for the engine design. Engines are typically optimized for a particular commercial fuel type, be it diesel, gasoline, methane, or propane, and each of these fuels requires a different compression ratio and engine controls to operate at highest efficiency. In the case of gaseous fuels it has been determined that an alternative fuel gas stream may comprise hydrocarbon components other than methane, but which still has a HV equivalent to methane. In general, it is the HV that most greatly affects engine performance, regardless of the composition of the fuel gas; said another way, two gas streams may have greatly different compositions, yet very nearly equal HVs (see Table 1). Either of the two gases in Table 1 would be suitable fuel gases.

The problem presented is how to modify the produced natural gas stream to yield a fuel gas stream of the desired HV. One option is to process the natural gas stream by methods known in the art (including fractionation, cryogenic processing, etc.) to yield one stream comprising essentially methane only, and one or more other gas and/or liquid streams comprising the remaining hydrocarbon components (which are then transported away and sold). This method gives rise to issues associated with dealing with the non-methane components, the requirement for significant processing equipment, etc. It is readily understood that processing natural gas into its constituent parts adds considerably to the cost of operation, so the ability to use the unprocessed or raw stream is a great advantage.

It is to be understood that similar issues may apply to the use of other gas streams (other than a produced gas stream) as fuel gas, for example containerized propane, butane, etc.

This and other prior art methods have various limitations.

### SUMMARY OF THE INVENTION

Apparatus, and method of same, embodying the principles of the present invention comprises a fuel gas system operatively coupled to an internal combustion engine. The internal combustion engine may be any type of engine, including but not limited to a reciprocating (piston) engine, a turbine, a “rotary” engine, or any other type. In addition, the system may be used to provide a gas stream of a desired HV to any other apparatus which burns or combusts such a gas stream.

The fuel gas system comprises an accumulator tank which receives gas streams from at least two, possibly more, sources. One source is the primary fuel source or high HV gas source, which may be a produced natural gas stream. As an alternative or backup, liquid propane or other hydrocarbon from a container or tank (thereafter gasified) may provide the high HV gas or primary fuel source. Yet another alternative is a gas stream in the nature of a propane gas stream produced by a refinery or similar installation. The second source is the low HV gas source, which may be an inert gas such as nitrogen, which may be provided through gasification of liquid nitrogen on site; or alternatively may be exhaust gases emitted from the engine, or ambient air. In some cases the low HV gas may be the primary fuel source but has an HV too low for the engine requirements (such as biogas), which is in substance the reverse problem from the above-described one (namely, that the primary fuel source has a too-high HV). The process is substantively the same, however, in that the low HV gas is mixed with high HV gas to yield the desired HV level. The high HV gas source and low HV gas source are mixed (e.g., mixing in an accumulator tank) at an appropriate ratio to yield a blended fuel gas stream with an appropriate HV for the given engine, and the blended fuel gas flows from the accumulator tank to the engine.

Preferably, an oxygen or O2 sensor in the exhaust gas stream senses how rich or lean the engine exhaust is, and via a control system with appropriate valving, pressure regulators, sensors, digital processors, etc. controls the high HV/low HV gas mixing ratio. It is understood that an exhaust gas stream that is too rich (O2 too low) will prompt the system to increase the amount of inert or low HV gas in the ratio; an exhaust gas stream that is too lean (O2 too high) will result in an increase in the amount of high HV or fuel gas in the ratio.

The accumulator tank comprises a pressure monitor system which signals a change in engine load, and consequently blended gas volume (rate) required to be fed to the engine. With increased load, flow control valves on both the high HV and low HV gas lines open further in unison to maintain the desired flow ratio. A decreasing load results in the opposite action.

It is understood that piping, controls, sensors, digital processors, etc., as known in the art, are present in the system.

### BRIEF DESCRIPTION OF THE DRAWINGS

FIG. 1 is a simplified view of the apparatus embodying the principles of the present invention.

FIG. 2 is a more detailed diagram setting out certain elements of the apparatus.

FIG. 3 is a perspective view of one embodiment of the apparatus.

FIGS. 4 and 5 are additional views of the apparatus mounted in a frame, FIG. 5 showing shrouding doors in place on the frame.

### DESCRIPTION OF THE PRESENTLY PREFERRED EMBODIMENT(S)

While various fuel gas monitoring and modification systems can be made, embodying the principles of the present invention, with reference to the drawings some of the presently preferred embodiments can be described.

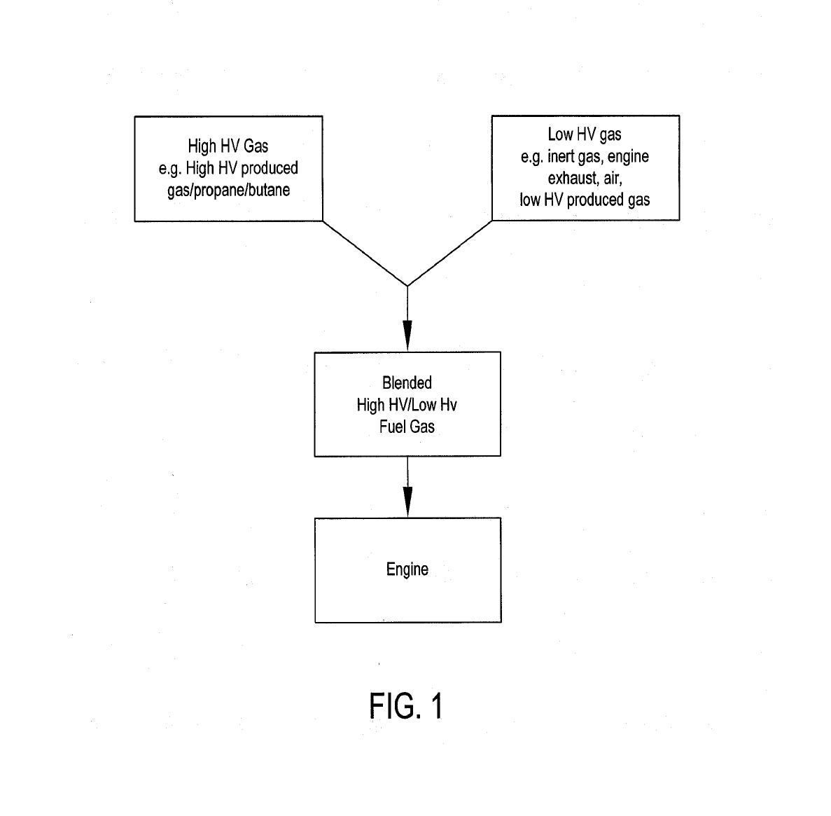

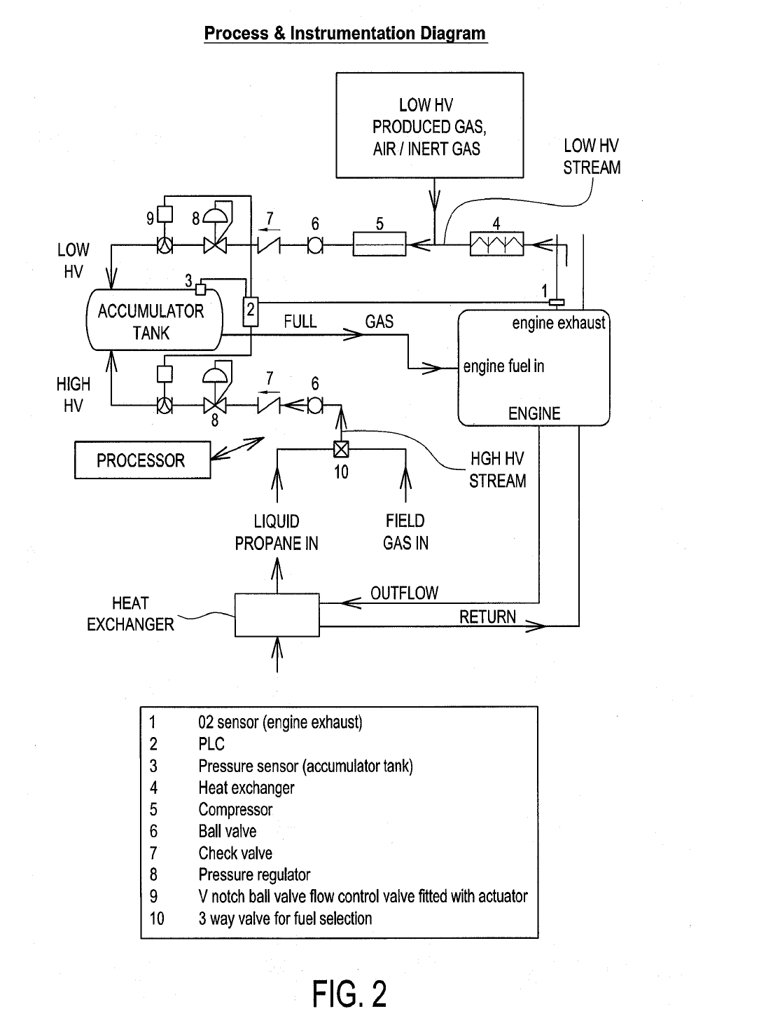

FIG. 1 is a simplified diagram of the system of the present invention, broadly illustrating the fundamental elements of the system. FIG. 2 is a diagram setting forth additional detail of an exemplary system. An accumulator tank, shown, receives two gas streams: a (relatively) high HV stream, as labeled; and a (relatively) low HV stream, as labeled. For convenience, these two streams will be referred to as the “high HV stream” and the “low HV stream.” A fuel line carries a blended fuel gas stream (that is, a blend of the high HV stream and the low HV stream) from the accumulator tank to the engine, labeled. The blended fuel gas stream has properties, primarily a HV figure, which permit efficient operation of the engine. As shown in FIG. 2, the high HV stream may comprise “field gas,” namely natural gas produced from one or more oil/gas wells, in substantially a non-processed state, having undergone only primary separation (to separate hydrocarbon liquids and water from the natural gas, still leaving typically a relatively rich natural gas stream). Alternatively, the high HV stream may comprise propane or other hydrocarbon, stored in liquid state on site, as all or part of the stream. An appropriate valve 10 controls this gas stream flow.

It is understood that still other sources may comprise the HV fuel stream and the scope of the present invention encompasses any such sources. As a further example, the HV stream may comprise propane or other hydrocarbon produced in a refinery or similar installation, which may comprise an “excess” gas stream from the refinery.

The internal combustion engine may be any type of engine using a gas fuel stream, including but not limited to a reciprocating (piston) engine, a turbine, a “rotary” engine, or any other type.

Typically, a valve, which may be a ball valve 6, a check valve 7, a pressure regulator 8, and a flow control valve 9 (which may be a v-notch ball valve, and which is fitted with an actuator) are installed in the flowline of the high HV stream, and control flow of that stream into the accumulator tank. As described in more detail later, flow control valve 9 is responsive to readings from the O2 (oxygen) sensor, 1; and related PLC (programmable logic controller), 2.

As an alternative to an O2 sensor, a chromatograph can be used to determine the richness of the fuel gas stream.

The other input to the accumulator tank is the low HV stream. In the embodiment shown in FIG. 2, one of the possible sources for the low HV gas stream is exhaust gas from the engine. The exhaust gas (from engine exhaust outlet, noted) is flowed through a heat exchanger 4, to lower the temperature to an acceptable value; through a compressor 5, to achieve the desired pressure; then through a ball valve 6, a check valve 7, a pressure regulator 8, and a flow control valve 9 (which may be a v-notch ball valve, and which is fitted with an actuator) and control flow of that stream into the accumulator tank. As described in more detail later, flow control valve 9 is responsive to readings from the O2 (oxygen) sensor, 1; and related PLC (programmable logic controller), 2.

Alternatively, rather than use of exhaust gas from the engine, ambient air may be used as the low HV gas source. Use of air (which is still compressed before flowing to the accumulator tank) avoids the need for a heat exchanger and cooling of the low HV stream. In FIG. 1, in the event that ambient air, or an inert gas such as nitrogen, is to be used as the low HV gas, the air or inert gas is introduced to the low HV flowstream generally as noted (downstream of heat exchanger 4, which is not needed, and upstream of compressor 5, so that the air or inert gas can be compressed). It is understood that the scope of the present invention encompasses all low HV sources.

The system monitors the overall HV of the fuel gas stream and adjusts the ratios (relative flowrates) of the high HV and low HV streams to yield a fuel gas with a suitable HV. Oxygen sensor 1 detects oxygen level in the engine exhaust; if the O2 level in the exhaust is too high, then there is insufficient high HV gas, and via PLC (2), and flow control valves 9, the flow rates are adjusted (in relative terms) to increase HV gas flow. Alternatively, if the O2 level in the exhaust is too low, then there is too much high HV gas, and via PLC (2), and flow control valves 9, the flow rates are adjusted (in relative terms) to decrease HV gas flow.

The accumulator tank also comprises pressure sensor 3. When pressure sensor 3 senses a decrease in the accumulator tank pressure, indicating increased fuel demand by the engine, then via pressure sensor 3, PLC 2, and flow control valves 9, flow rate from the accumulator tank is increased by opening both flow control valves in unison, thereby preserving the high HV/low HV ratio then in place. It is understood that a decrease in fuel demand results in an opposite action.

Any liquids which drop out of the combined gas streams in the accumulator tank can be evacuated via a liquid dump valve at the base of the accumulator tank. Strainers and filters as appropriate may be placed in the gas flow lines to ensure that no solids enter the system.

It is understood that the system can also be used to increase the HV of a gas source, to make it suitable for a fuel gas; e.g., if the primary gas source is a relatively low HV gas, such as bio-gas, then the HV of the blended fuel gas stream can be increased by the addition of propane or other relatively high HV gas.

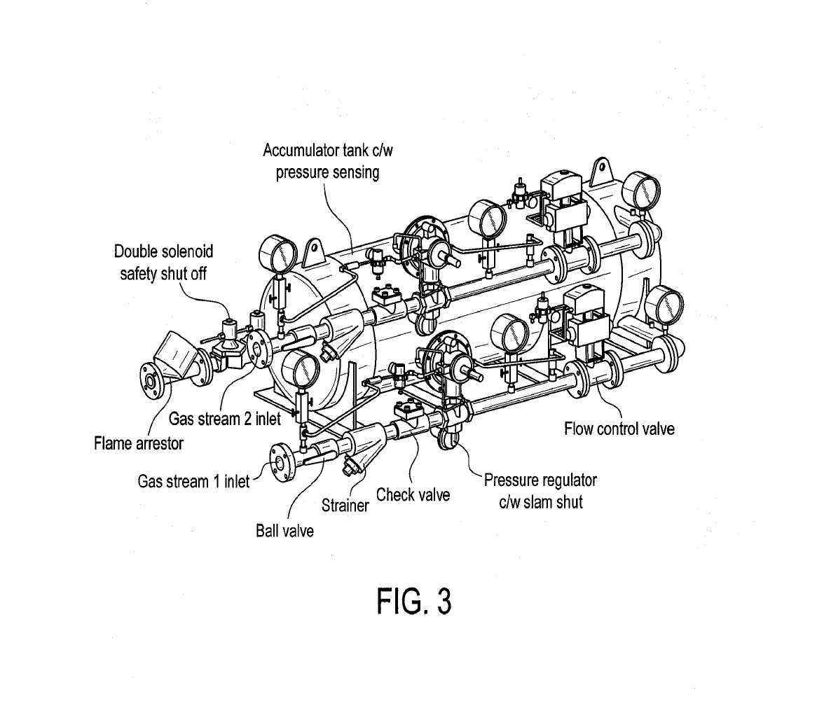

FIG. 3 is a perspective view of an embodiment of the system, generally as depicted in FIG. 1, with various components labeled.

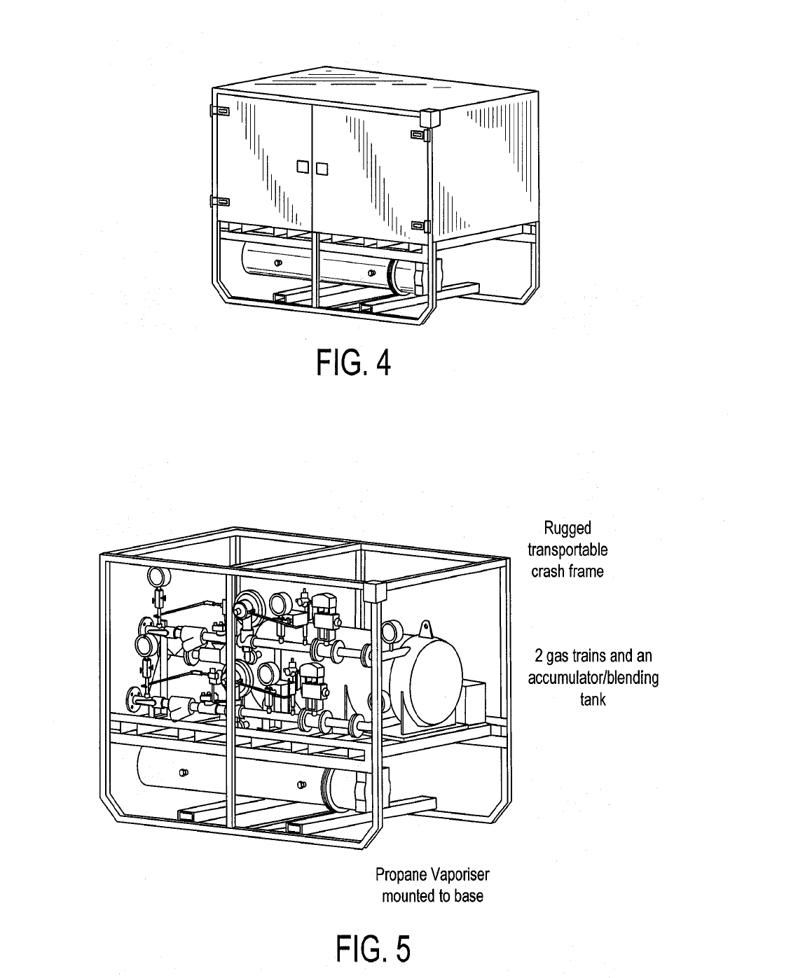

FIGS. 4 and 5 depict the key components of the system mounted in or on a frame, with FIG. 5 also showing protective or shroud doors in place on the frame.

Note that one or more digital processors are operatively connected to the various components of the system, to permit efficient operation.

### Use of the System

An exemplary use of the system can be described. The fuel gas system, as noted above, can be mounted within a frame and transported to a desired location, for example a well pad on which are located one or more producing oil/gas wells, and at which is located an internal combustion engine. The engine may be used to drive an electric generating unit or for any other purpose. The gas stream from the on-site separator system (into which the overall flowstream from the well is flowed) can serve as the high HV stream, and connected to the inlet labeled in FIG. 2 as “field gas in.” A suitable low HV stream is connected, depending upon the HV (and other) characteristics of the HV stream. As noted above, the low HV stream may comprise (by way of example only) ambient air, exhaust from the engine, or gasified nitrogen (typically brought on site in a liquid state).

The characteristics of the engine are sufficiently known that some estimate of high HV/low HV ratio (a starting ratio) can be made. The high HV and low HV streams are then flowed to the accumulator tank in a desired ratio, the mixture flowed as fuel gas to the engine, and the engine started. Via oxygen sensor 1 feeding signals to PLC 2, and thence controlling flow control valves 9, the appropriate high HV/low HV mixture can be obtained and retained. As noted above, one or more digital processors enable collection of operating data and use of same to adjust flow conditions.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof.

Therefore, the scope of the invention is to be determined not by the illustrative examples set forth above, but by the appended claims and their legal equivalents.

TABLE 1

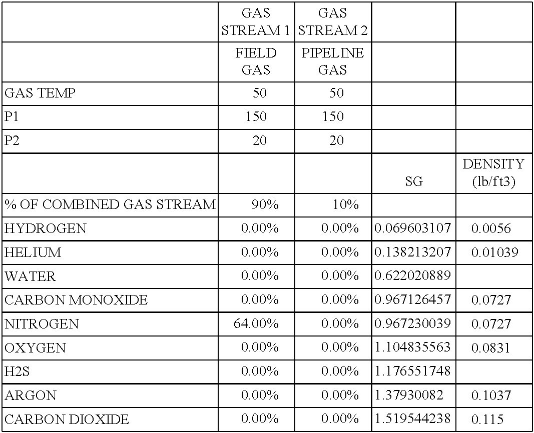

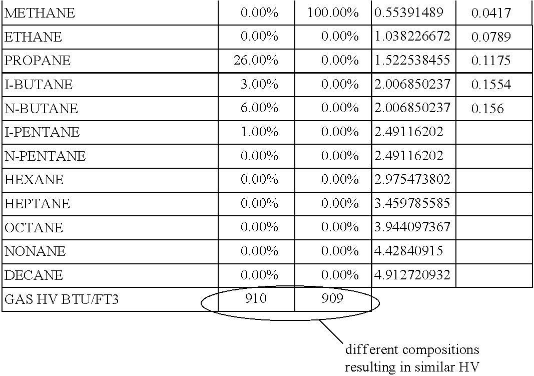

I claim:

1. A system for producing a gaseous fuel stream of a desired composition for an internal combustion engine, comprising:
a relatively high heating value gas source;
a relatively low heating value gas source;
a means for blending the relatively high and low heating value gas sources; and
a means for adjusting the respective flow rates of the relatively high heating value gas source and the relatively low heating value gas source.

2. The system of claim 1, further comprising:
a means for analyzing the composition of the blended gas stream; and
a means for supplying the blended gaseous fuel stream to an internal combustion engine.

3. The system of claim 1, wherein said relatively high heating value gas source comprises a gas stream from an oil and/or gas well.

4. The system of claim 1, wherein said relatively high heating value gas source comprises gas from a containerized liquified gas source.

5. The system of claim 1, wherein said relatively low heating value gas source comprises nitrogen.

6. The system of claim 1, wherein said relatively low heating value gas source comprises ambient air.

7. The system of claim 1, wherein said relatively low heating value gas source comprises engine exhaust gas.

8. The system of claim 1, wherein said relatively high heating value gas source comprises a gas stream from an oil and/or gas well; and
said relatively low heating value gas source comprises nitrogen.

9. The system of claim 1, wherein:
said relatively high heating value gas source comprises a gas stream from an oil and/or gas well; and
said relatively low heating value gas source comprises ambient air.

10. The system of claim 1, wherein:
said relatively high heating value gas source comprises a gas stream from an oil and/or gas well; and
said relatively low heating value gas source comprises engine exhaust gas.

11. The system of claim 1, wherein:
said relatively high heating value gas source comprises gas from a containerized liquified gas source; and
said relatively low heating value gas source comprises nitrogen.

12. The system of claim 1, wherein:
said relatively high heating value gas source comprises gas from a containerized liquified gas source; and
said relatively low heating value gas source comprises ambient air.

13. The system of claim 1, wherein:
said relatively high heating value gas source comprises gas from a containerized liquified gas source; and
said relatively low heating value gas source comprises engine exhaust gas.

14. The system of claim 1, wherein:
said means for blending the relatively high and low heating value gas sources comprises one or more flow control valves independently controlling flow from said relatively high and relatively low heating value gas sources;
said means for analyzing the composition of the blended gas stream comprises an oxygen sensor which measures oxygen in an exhaust stream from said engine;
said means for adjusting the respective flow rates of the relatively high and relatively low heating value gas sources comprises a programmable logic controller which receives input from said oxygen sensor, and which is operatively connected to actuators on said flow control valves which can adjust flow rates through said flow control valves in response to a signal from said programmable logic controller; and
further comprising one or more digital processors operatively coupled to said system.

15. The system of claim 14, wherein said relatively high heating value gas source comprises a containerized liquified gas source, and further comprising a heat exchanger which receives heat from an exhaust stream from said engine, and transfers said heat to said liquified gas source flowing through said heat exchanger, thereby gasifying said liquified gas source.

16. The system of claim 1, wherein said relatively high heating value gas source comprises a liquified gas source, and further comprising a heat exchanger which receives heat from an exhaust stream from said engine, and transfers said heat to said liquified gas source flowing through said heat exchanger, thereby gasifying said liquified gas source.

17. A system for producing a gaseous fuel stream of a desired composition for an internal combustion engine, comprising:
a relatively high heating value gas source;
a relatively low heating value gas source;
a means for blending the relatively high and low heating value gas sources comprising one or more flow control valves independently controlling flow from said relatively high and relatively low heating value gas sources, said gas sources flowing into an accumulator tank;
a means for adjusting the respective flow rates of the relatively high heating value gas source and the relatively low heating value gas source comprising a programmable logic controller which receives input from said oxygen sensor, and which is operatively connected to actuators on said flow control valves which can adjust flow rates through said flow control valves in response to a signal from said programmable logic controller;
a means for analyzing the composition of the blended gas stream comprising an oxygen sensor which measures oxygen in an exhaust stream from said engine;
a means for supplying the blended gaseous fuel stream to an internal combustion engine; and
one or more digital processors operatively coupled to said system.

18. A method for producing a fuel gas stream of a desired heating value, from at least a relatively high heating value gas source and a relatively low heating value gas source, comprising the steps of:
a) providing a fuel gas blending system comprising:
a means for blending said relatively high and low heating value gas sources; and
a means for adjusting the respective flow rates of said relatively high and low heating value gas sources;
b) flowing gas from said relatively high and relatively low heating value gas sources to said fuel gas blending system and blending said relatively high and relatively low heating value gases, forming a blended fuel gas stream;
c) analyzing the composition of said blended fuel gas stream;
d) adjusting the flows of said relatively high and relatively low heating value gases, as required, to yield a desired composition of said blended fuel gas stream; and
e) flowing said desired composition of blended fuel gas to an internal combustion engine.

19. The method of claim 18, wherein said relatively high heating value gas source is an oil and/or gas well.

20. The method of claim 18, wherein said relatively high heating value gas source is a containerized liquified gas.
